(19) United States
(12) Patent Application Publication
(10) Pub. No.: US 2025/0037080 A1
(43) Pub. Date: Jan. 30, 2025

(54) METHOD, APPARATUS, ELECTRONIC DEVICE AND STORAGE MEDIUM FOR INFORMATION PROCESSING

(71) Applicant: Beijing Zitiao Network Technology Co., Ltd., Beijing (CN)

(72) Inventors: Gaoyi Li, Beijing (CN); Zhaojun Wang, Beijing (CN); Han Yin, Beijing (CN); Yao Wang, Beijing (CN); Zisheng Liu, Beijing (CN)

(21) Appl. No.: 18/716,020

(22) PCT Filed: Nov. 28, 2022
(86) PCT No.: PCT/CN2022/134708

§ 371 Date: Jun. 3, 2024

(30) Foreign Application Priority Data
Dec. 3, 2021 (CN) 202111466162.0

(51) Int. Cl. G06Q 10/10

(52) U.S. Cl. CPC G06Q 10/103

(57) ABSTRACT

The present disclosure provides a method, apparatus, electronic device, and storage medium for information processing. A method of information processing provided by embodiments of the present disclosure includes: in response to processing of a first item, determining processing information of the first item, the processing information including: processing path information and/or processing duration information for processing the first item; determining whether the processing information satisfies the predetermined judgment condition; and in response to the processing information satisfying the judgment condition, display first predetermined information. The method of information processing proposed by the embodiments of the present disclosure may issue a reminder when a path or a duration in which a processing staff processes the first item satisfies the judgment condition, so as to avoid a risk caused by carelessness of the processing staff.

### CROSS REFERENCE

This application claims priority to Chinese Patent Application No. 202111466162.0 filed on Dec. 3, 2021, and entitled “METHOD, APPARATUS, ELECTRONIC DEVICE AND STORAGE MEDIUM FOR INFORMATION PROCESSING”, the disclosure of which is incorporated herein by reference in its entirety.

### FIELD

The present disclosure relates to the field of computer technology, and in particular, to a method, an apparatus, an electronic device and a storage medium for information processing.

### BACKGROUND

In scenarios such as intra-team and inter-team collaboration, some items (for example approval tasks) and/or the like need to be processed. When processing the items, a processing staff needs to fully understand the items so that he/she may handle the items.

### SUMMARY

The present disclosure provides a method, an apparatus, an electronic device and a storage medium for information processing.

The present disclosure utilizes the following technical solutions.

In some embodiments, the present disclosure provides a method of information processing, including:

in response to processing of a first item, determining processing information of the first item, the processing information including: processing path information and/or processing duration information for processing the first item:

determining whether the processing information satisfies a predetermined judgment condition; and

in response to the processing information satisfying the judgment condition, display first predetermined information.

In some embodiments, the present disclosure provides a device for information processing, including:
a determining unit configured to in response to processing of a first item, determine processing information of the first item, the processing information including: processing path information and/or processing duration information for processing the first item;
a judgment unit configured to determine whether the processing information satisfies a predetermined judgment condition;
a displaying unit configured to in response to the processing information satisfying the judgment condition, display first predetermined information.

In some embodiments, the present disclosure provides an electronic device including:
at least one memory and at least one processor;
where the at least one memory is configured to store program codes, and the at least one processor is configured to call the program codes stored in the at least one memory to perform the above method.

In some embodiments, the present disclosure provides a computer readable storage medium for storing program codes, the program codes, upon run by a processor, causing the processor to perform the above method.

A method of information processing according to the embodiments of the present disclosure, includes: in response to processing of a first item, determining processing information of the first item, the processing information including: processing path information and/or processing duration information for processing the first item; determining whether the processing information satisfies a predetermined judgment condition; and in response to the processing information satisfying the judgment condition, display the first predetermined information. The method of information processing proposed by the embodiments of the present disclosure may issue a reminder when a path or a duration in which a processing staff processes the first item satisfies the judgment condition, so as to avoid a risk caused by abnormal processing in the processing of the first item by the processor.

### BRIEF DESCRIPTION OF THE DRAWINGS

The above and other features, advantages, and aspects of various embodiments of the present disclosure will become more apparent in conjunction with the accompanying drawings and with reference to the following detailed description. Throughout the accompanying drawings, the same or similar reference numbers refer to the same or similar elements. It should be understood that the accompanying drawings are schematic and that components and elements are not necessarily drawn to scale.

FIG. 1 is a flowchart of a method of information processing according to embodiments of the present disclosure.

FIG. 2 is a schematic diagram of a displaying interface according to embodiments of the present disclosure.

FIG. 3 is a schematic diagram of a setting interface according to embodiments of the present disclosure.

FIG. 4 is a schematic diagram of a statistics interface according to embodiments of the present disclosure.

FIG. 5 is a schematic structural diagram of an electronic device according to embodiments of the present disclosure.

### DETAILED DESCRIPTION

Embodiments of the present disclosure will be described in more detail below with reference to the accompanying drawings. Although certain embodiments of the present disclosure are shown in the accompanying drawings, however it should be understood that the present disclosure may be implemented in various forms and should not be construed as being limited to the embodiments set forth herein, but rather these embodiments are provided for a more thorough and complete understanding of the present disclosure. It should be understood that the accompanying drawings and embodiments of the present disclosure are for illustrative purposes only and are not intended to limit the scope of the present disclosure.

It should be understood that the individual steps described in the method embodiments of the present disclosure may be performed in parallel in accordance with “and/or”. Furthermore, the method embodiments may include additional steps and/or omit performing the illustrated steps. The scope of the present disclosure is not limited in this regard.

The term “include” and its variations, as used herein, are open-ended, i.e. “including, but not limited to”. The term “based on” means “based at least in part on”. The term “an embodiment” means “at least one embodiment”; the term “another embodiment” means “at least one further embodiment”; the term “some embodiments” means “at least some embodiments”. Relevant definitions of other terms will be given in the following description.

It should be noted that the concepts of “first” and “second” and/or the like mentioned in the present disclosure are only used to distinguish different devices, modules or units, and are not used to limit the order or interdependence of functions performed by these devices, modules or units

It should be noted that the modification of “a” mentioned in the present disclosure is illustrative rather than limiting. Those skilled in the art will understand that unless the context clearly indicates otherwise, it should be understood as “one or more”.

The names of messages or information interacted among the plurality of devices in the embodiments of the present disclosure are used only for the purposes of illustration and are not intended to limit the scope of these messages or information.

The solution provided by the embodiments of the present disclosure will be described in detail below in conjunction with the accompanying drawings.

In scenarios such as intra-team and inter-team collaboration, items need to be processed. When processing the items, the processing staff needs to have a certain understanding of the items to ensure that the processing staff processes the items carefully to avoid abnormal approval and other behaviors as much as possible. Taking approval items as an example, approval items often involve a plurality of nodes, and the processing staffs of the nodes may be the approvers. The approvers need to process the approval items carefully, and if the approvers perform abnormal approvals (for example, the approvals are processed without understanding the specific contents of the approval items, that is, processing the approval items without checking the detailed information of the approval items), problems may be caused in the approval. Administrators as well as the person in charge of the approval items need to know whether there are any abnormal approvals or other behaviors by the approver to ensure that the approval items are processed carefully to avoid problems.

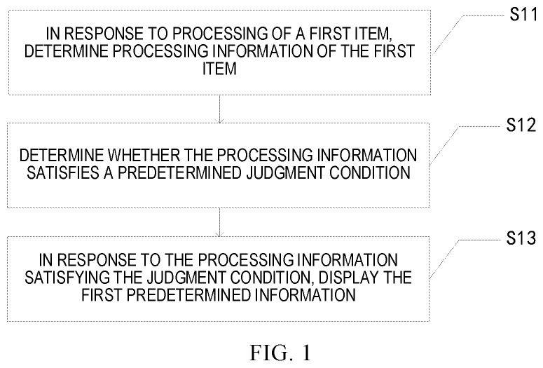

As shown in FIG. 1, which is a flowchart of a method of information processing according to embodiments of the present disclosure, the following steps are included.

In S11, in response to processing of a first item, the processing information of the first item is determined.

In some embodiments of the present disclosure, the first item may, for example, be an approval item or an item in a certain flow node of the approval item, and the person who processes the first item may be an approver of a certain flow node of the approval item. The processing refers to an operation to complete the processing of the first item. The first item may be ended or flowed to other nodes for further processing by other people. The processing may be, for example, agreeing to the first item, rejecting the first item, returning the first item to a flow node, and/or the like. The processing information includes: processing path information and/or processing duration information for processing the first item. Herein, the processing path information may include a page viewed and a location of a control triggered when processing the first item. In some embodiments, the processing path information may include a processing path. The processing path may include a quick processing path and a non-quick processing path, where the processing via the quick processing path may, for example, refer to processing by a quick processing control displayed in a notification message of the first item, and the processing via the non-quick processing path may refer to processing of the first item on the details page of the first item. The processing duration information may refer to a length of time from the processing staff (for example, may be the current user) starting the processing of the first item to completing the processing of the first item. For example, the processing staff receives a notification message to process the first item, it is detected that the processing staff has viewed the notification message, and then the processing staff, who has received the notification message, triggers the processing control displayed on the notification message to complete the processing of the first item. In this case, the processing duration is a length of time from the processing staff viewing the notification message to completing the processing.

In S12, it is determined whether the processing information satisfies a predetermined judgment condition.

In some embodiments, it is determined whether the predetermined judgment condition is satisfied based on the processing path information and/or the processing duration. For example, if the processing path information displays that the processing of the first item is performed by the processing staff via the quick processing path, it is determined that the predetermined judgment condition is satisfied. For another example, if the processing duration displays that the processing duration of the processing staff is less than a warning value, which means that the processing staff did not check the content of the first item in detail, then it may also be considered that the predetermined judgment condition is satisfied. In some embodiments, the judgment condition is used to judge whether the processing by the processing staff is careless. That is, satisfying the predetermined judgment condition indicates that the first item is processed without full understanding of the details of the first item, which indicates that the processing of the first item by the processing staff is too careless.

In S13, in response to the processed information satisfying the judgment condition, first predetermined information is displayed.

In some embodiments, the first predetermined information is used to indicate that the processing of the first item is too careless, and the first predetermined information may, for example, be “the processing duration is too short, and there may be an abnormal approval behavior”. In some embodiments, the first predetermined information may be displayed in a processing record of the first item.

In order to better illustrate the method proposed in the embodiments of the present disclosure, a specific embodiment is proposed below. Taking the processing of the first item as an example of the processing of the approval item, the first item may be an item that needs to be processed in a flow node of the approval item, for example, agreeing to the approval item, rejecting the approval item, and/or the like. After an approval item is established, the approval item has a processing flow. The processing flow includes one or more flow nodes, and the flow nodes need to be processed by the corresponding processing staffs. At a flow node, if it is detected that a processing staff is processing the approval item, one or both of the processing path and processing duration of the processing of the approval item by the processing staff are be detected as the processing information, and it is be determined whether the processing information satisfies the judgment condition. For example, if the approval item is processed by the quick processing control in the notification message, then it is determined that the judgment condition is satisfied, which indicates that the processing staff has processed it too carelessly. In order to facilitate the detailed information to be understood, in this case, the first predetermined information is displayed. The first predetermined information may be displayed in an area associated with the flow node, for example, displayed in an area associated with the processing staff of the flow node to indicate that the processing staff has performed the abnormal processing (for example, the processing is too careless).

In some embodiments of the present disclosure, the processing path information includes: information on whether to enter a details page of the first item during a processing procedure. In some embodiments, the details page of the first item is used to display the detailed information of the first item. If the first item being processed without entering the details page of the first item, which indicates that the processing staff does not understand the first item in detail, then it may be considered that the judgment condition is satisfied. In some embodiments of the present disclosure, the processing duration information includes: a stay duration on the details page. In some embodiments, the stay duration of the processing staff on the details page determines an understanding degree that he or she may understand the first item. If the stay duration of the processing staff on the details page is too short, which indicates that the processing staff has not fully understood the specific content of the first item, then the judgment condition is satisfied. In this case, the first predetermined message needs to be displayed. For example, the first predetermined message may be displayed immediately on the display interface after the processing staff processes the first item, or the first predetermined message may be sent to a predetermined terminal.

In some embodiments of the present disclosure, determining whether the processed information satisfies the predetermined judgment condition includes: if the details page is not entered during the processing procedure, the judgment condition is satisfied; if the details page is entered during the processing procedure, it is determined whether the judgment condition is satisfied based on the stay duration on the details page. In some embodiments, if the details page of the first item is not entered during the processing of the first item, that is, the details of the first item are not viewed and the first item is certainly not be able to be fully understood, then the judgment condition is satisfied and the first predetermined information needs to be displayed. If the details page of the first item is entered during the processing procedure, which indicates that there is a further understanding of the first item, then it needs to be further determined whether the judgment condition is satisfied based on the stay duration on the details page.

In some embodiments of the present disclosure, determining whether the processing information satisfies the predetermined judgment condition includes: if the details page is not entered during the processing procedure and the first item is not processed in a predetermined mode, the judgment condition is satisfied; if the details page is entered during the processing procedure, it is determined whether the judgment condition is satisfied based on the stay duration on the details page. If the first item is processed in the predetermined mode, the judgment condition is unsatisfied. In some embodiments of the present disclosure, there is a need for fast processing of portions of items, and in this case, the predetermined mode may be set in advance. If the processing is performed in the predetermined mode, even if the details page of the first item is not entered, the judgment condition is unsatisfied, and the first predetermined information is not displayed. In some embodiments, the predetermined mode is a mode to process the first item without entering the details page. This facilitates fast processing by reserving a number of modes.

In some embodiments of the present disclosure, the predetermined mode includes at least one of: batch processing of items, or processing of items via an open interface. In some embodiments, the batch processing may be performed on the items in an items list, and in this case, a plurality of items are processed uniformly. In other embodiments, the open interface is an interface applied for interfacing with other platforms. For example, the executor of the method proposed in the embodiments of the present application may be a system, which provides an open interface exposed to the public for interfacing with an external system. In a case of interfacing with the external system, it may not be possible to accurately know whether the processing staff fully understands the first item due to permissions and/or the like. Thus, in this case, it is considered that the judgment condition is unsatisfied.

In some embodiments of the present disclosure, determining whether the judgment condition is satisfied based on the stay duration on the details page, includes: if the stay duration is less than a predetermined duration, the judgment condition is satisfied; if the stay duration is greater than or equal to the predetermined duration, the judgment condition is unsatisfied. In some embodiments, if the stay duration on the details page is less than the predetermined duration, which indicates that the user has not carefully viewed the specific content of the first item, then it is determined that the judgment condition is satisfied. The first predetermined information needs to be displayed. If the stay duration is greater than or equal to the predetermined duration, which indicates that the processing staff has a full understanding of the first item, then it is determined that there is no need to display the first predetermined information, that is, the judgment condition is unsatisfied.

In some embodiments of the present disclosure, the details page is not entered for processing by: processing the first item via a processing control in a notification message corresponding to the first item, or processing the first item via a processing control in an item list. In some embodiments, after the first item is generated, a notification message may be sent to the displaying interface of the processing staff of the first item to notify the processing staff of the processing. The notification message of the displaying interface may be displayed in the form of a notification card. The processing controls, such as agree, reject, and/or the like, for processing the first item may be displayed in the notification message. In some embodiments, after the first item is generated, the first item may be displayed in the item list of the displaying interface, and the processing control for the first item is displayed in the item list. The processing staff may process the first item in the item list without entering the details page of the first item. In some embodiments, brief information of the first item is displayed in the notification message and the item list.

In some embodiments of the present disclosure, the details page is entered for processing by: displaying the details page for processing, after the notification message is triggered; or displaying the details page for processing, after the item list is triggered. In some embodiments, a notification message is triggered by clicking, long pressing, and/or the like, after the notification message associated with the first item is triggered, the details page of the first item may be displayed. After the details page of the first item is displayed, it is considered to enter the first item. In some embodiments, the first item in the list of items is triggered by clicking, long pressing, and/or the like, so as to enter the details page of the first item.

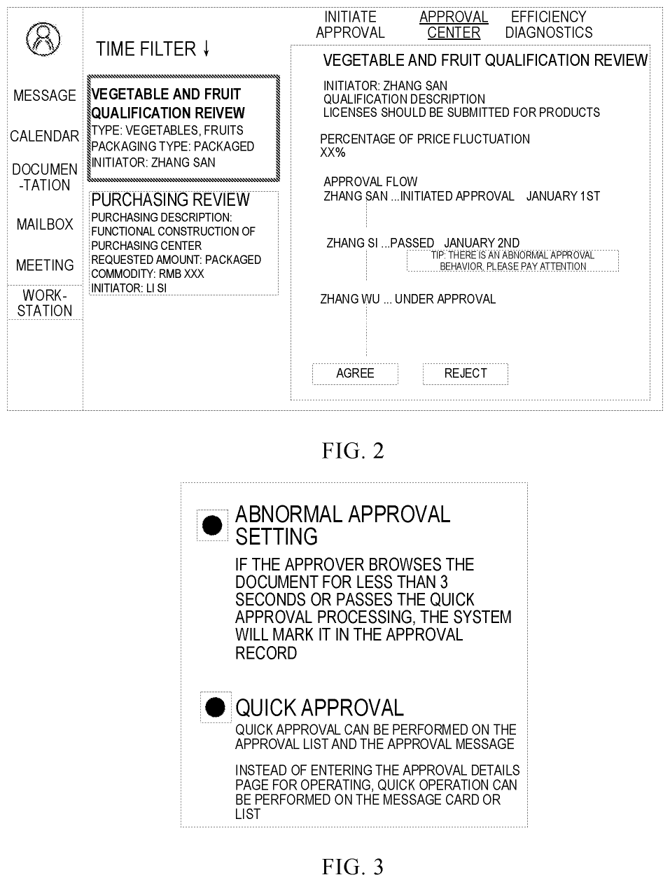

In order to better illustrate the approach of determining whether the predetermined judgment condition is satisfied in the embodiments of the present disclosure, a specific embodiment is proposed below. In this embodiment, after the first item is generated, a notification message of the first item may be sent to the processor, and the list of the first item may be displayed in the item list associated with the processing staff. A control for processing the first item, for example the quick approval control, may be displayed in a notification message and an item list. If the first item is processed via a control displayed in a notification message or an item list, it is considered that the judgment condition is satisfied and it is an abnormal approval. For the notification message or item list of the first item, if the processing staff triggers the notification message or the item list, the details page of the first item may be displayed, for example, as shown in FIG. 2. Notification cards (notification messages) for two items are displayed under “Time Filter” on the left side of FIG. 2, namely “Vegetable and Fruit Qualification Review” and “Purchasing Review”. By clicking the notification card, the details page of the item is displayed on the right side in FIG. 2. “Agree”. “Reject” and other controls for processing the item may be displayed in the details page. If the first item is processed in the details page and the stay duration in the details page reaches a predetermined duration (for example 3 seconds, 5 seconds or 10 seconds, etc.), it is considered that the judgment condition is unsatisfied. If the details page being not entered, or the stay duration on the details page does not reach the predetermined duration, it is considered that the judgment condition is satisfied and it is an abnormal approval. In this case, the first predetermined information needs to be displayed. If batching processing is performed on the items in the item list, or the first item is processed via an open interface of a system, then it is considered that the judgment condition is satisfied and it is not an abnormal approval. The first predetermined information is not displayed.

In some embodiments of the present disclosure, if a same user enters the details page of the first item using different terminals, the stay duration on the details page is calculated from an earliest time point when the user enters the details page using the different terminals. In some embodiments, the user (or processing staff) may process the first item via a mobile phone, a computer, and/or the like. The user may view the details page of the first item using the mobile phone and then process it using the computer. At this time, the stay duration on the details page of the first item may be calculated from an earliest time point when the user enters the details page, so as to ensure the accuracy of the calculation of the stay duration.

In some embodiments of the present disclosure, if the details page is entered during the processing procedure and processing of the first item is completed outside the details page, then it is determined whether the judgment condition is satisfied, according to a duration from entering of the details page to completing of the processing of the first item. In some embodiments, the processing staff may enter the details page of the first item during the processing of the first item, but the first item is processed by controls other than the details page of the first item. In this case, the stay duration is counted from entering of the details page of the first item to the completing of processing the first item. If the duration reaches the predetermined duration, it is considered that the judgment condition is unsatisfied; Otherwise, it is considered that the judgment condition is satisfied. For example, if the stay duration from entering of the details page to completing of the processing of the first item is less than 3 seconds, it is considered that the judgment condition is satisfied and it is an abnormal approval; otherwise, it is considered that the judgment condition is unsatisfied and it is not an abnormal approval.

In some embodiments of the present disclosure, in response to the processing of the first item, before determining the processing information of the first item, the method further includes: determining whether a first function is enabled for the first item; if the first function is enabled, determining the processing information of the first item; and otherwise, skipping the determining of the processing information of the first item. In some embodiments of the present disclosure, the executor of the method may set whether the first function is enabled. Only in the case that the first function is enabled, steps S11-S13 are performed; and otherwise, steps S11-S13 are not performed. Specifically, taking an approval item as an example, after the approval item is created, the processing flow of the approval item may be configured at the system (or the executor of the method). As shown in FIG. 3, the configuration includes “abnormal approval settings” (the first function). After enabling “abnormal approval settings”, if the processing information of the first item in the flow node of the approval item satisfies the judgment condition, the first predetermined information may be displayed.

In some embodiments of the present disclosure, the first function is enabled by default for the predetermined type of items. The predetermined type of items include at least one of: an amount-related item, or an item with an importance level reaching a predetermined level. In some embodiments, if the item is the amount-related item, or a more important item, then it is indicated that the item requires the attention of the processing staff. In this case, if the processing staff performs processing without entering the details page, then a prompt is needed. Thus, the first function is enabled by default for these types of items.

In some embodiments of the present disclosure, the method further includes: determining whether a second function is enabled for the first item; if the second function is disabled, the first item is only allowed to be processed after entering a details page of the first item. In some embodiments, as shown in FIG. 3, the second function may be a quick approval function. In the case that the second function is enabled, the first time may be processed in a notification message or in an item list, without entering the details page. If the second function is disabled, the quick processing controls in the notification message or the item list may be hidden, and the controls for processing the first item are only displayed in the details page. In this case, it is necessary to enter the details page for processing the first item, which ensures that when processing the first item, the processing staff has fully understanding of the first item.

In some embodiments of the present disclosure, the first item is an item of a target node of a processing flow of a target task; and displaying the first predetermined information includes: displaying the first predetermined information in an area associated with the target node of the processing flow.

In some embodiments, referring to FIG. 2, the target task may be an approval item. The target task has a processing flow, where there are one or more flow nodes in the processing flow. The first item may be an item that needs to be processed by the flow node. For example, the target task is a qualification review task shown in FIG. 2. The first item is to approve the target task, as shown in the corresponding displaying area below the approval center on the right side of FIG. 2. The processing flow may be displayed on the details page of the first item, for example, displaying who initiates the approval. who has passed the approval, and/or the like. Then, if the processing information of the processing staff of a certain flow node satisfies the judgment condition, the first predetermined information is displayed in an area associated with the flow node, for example. “Tip: There is an abnormal approval behavior, please pay attention” displayed in the area associated with the flow node where Zhang Si is located in FIG. 2, which indicates that Zhang Si has performed an abnormal approval. More specifically, the identification (for example an avatar) of the processing staff may be displayed in the area associated with the flow node of the processing flow, and then the first predetermined information is displayed in an area associated with the identification of the processing staff, thus enabling the person in charge of the target task or the administrator to know which processing staff has performed the operation of the abnormal approval.

In some embodiments of the present disclosure, the first predetermined information is not displayed in a printing result during printing of the first item. In some embodiments, the first item may be output by printing and/or the like. In this case, the first predetermined information may not be displayed in the printing result, because what is concerned may be a specific content and a current situation of the first item, while the first predetermined information is not displayed.

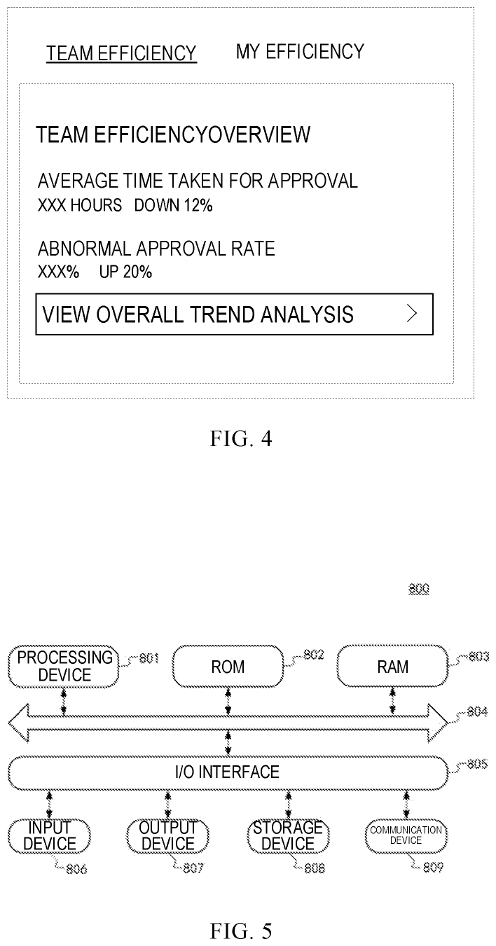

In some embodiments of the present disclosure, the method further includes: obtaining statistical data of the first predetermined information generated during the processing of the item, and displaying the statistical data. In some embodiments, the first predetermined information may be used to identify that the processing staff has performed behaviors of an abnormal approval. The statistical data of the first predetermined information may be a rate of the abnormal approvals of the processing staff, or the percentage of abnormal approvals in a team. The statistical data may be displayed in a statistical interface of the system. For example. “Efficiency Diagnosis” of the displaying interface in FIG. 2 may be used as the entrance of the statistical interface to enter a page for displaying statistical data. As shown in FIG. 4, statistical data on the number of people or the number of times that abnormal approvals are performed by a person or a team to generate the first predetermined information may be displayed in a statistical interface for displaying the statistical data. The statistics such as the number of times of abnormal approvals or the percentage of abnormal approvals may be viewed for the team and the subordinate teams of the team.

In some embodiments of the present disclosure, it also proposes an apparatus for information processing, including:
a determining unit configured to in response to processing of a first item, determine processing information of the first item, the processing information including: processing path information and/or processing duration information for processing the first item;
a judgment unit configured to determine whether the processing information satisfies a predetermined judgment condition;
a displaying unit configured to in response to the processing information satisfying the judgment condition, display first predetermined information.

In some embodiments, the processing path information includes: information on whether to enter a details page of the first item during a processing procedure; and/or

In some embodiments, the processing duration information includes: a stay duration on the details page.

In some embodiments, determining whether the processing information satisfies the predetermined judgment condition includes:

in response to the details page being not entered during the processing procedure, determining that the judgment condition is satisfied; and

in response to the details page being entered during the processing procedure, determining whether the judgment condition is satisfied based on the stay duration on the details page.

In some embodiments, determining whether the processing information satisfies the predetermined judgment condition includes:
in response to the details page being not entered during the processing procedure and the first item being not processed in a predetermined mode, determining that the judgment condition is satisfied;
in response to the details page being entered during the processing procedure, determining whether the judgment condition is satisfied based on the stay duration on the details page; and
in response to the first item being processed in the predetermined mode, determining that the judgment condition is unsatisfied.

In some embodiments, the predetermined mode includes at least one of: batch processing of items, or processing of items via an open interface.

In some embodiments, determining whether the judgment condition is satisfied based on the stay duration on the details page includes:
in response to the stay duration being less than the predetermined duration, determining that the judgment condition is satisfied; and
in response to the stay duration being greater than or equal to the predetermined duration, determining that the judgment condition is unsatisfied.

In some embodiments, the details page is not entered for processing by: processing the first item via a processing control in a notification message corresponding to the first item, or processing the first item via a processing control in an item list.

In some embodiments, the details page is entered for processing by: displaying the details page for processing, after the notification message is triggered, or displaying the details page for processing, after the item list is triggered.

In some embodiments, in response to a same user entering the details page of the first item using different terminals, the stay duration on the details page is calculated from an earliest time point when the user enters the details page using the different terminals.

In some embodiments, in response to the details page being entered during the processing procedure and processing of the first item being completed outside the details page, whether the judgment condition is satisfied is determined according to a duration from entering the details page to completing the processing of the first item.

In some embodiments, it also includes a controlling unit, the controlling unit configured to in response to the processing of the first item, before determining the processing information on the first item, determining whether a first function is enabled for the first item, in response to the first function being enabled, determine the processing information of the first item; and in response to the first function being disabled, skip the determining of the processing information of the first item.

In some embodiments, the first function is enabled by default for a predetermined type of items, the predetermined type of items including at least one of: an amount-related item, and an item with an importance level reaching a predetermined level.

In some embodiments, the controlling unit is used to: determine whether a second function is enabled for the first item; and in response to the second function being disabled, determine that the first item is only allowed to be processed after entering a details page of the first item.

In some embodiments, the first item is an item of a target node of a processing flow of a target task; and
displaying the first predetermined information includes: displaying the first predetermined information in an area associated with the target node of the processing flow.

In some embodiments, the first predetermined information is not displayed in a printing result, during printing the first item.

In some embodiments, the controlling unit is further configured to obtain statistical data of the first predetermined information generated during the processing procedure of the item and displaying the statistical data.

For the apparatus embodiments, since they basically correspond to the method embodiments, portions of the description of the method embodiments may be referred to. The apparatus embodiments described above are only illustrative, in which the modules described as separate modules may or may not be separate. Some or all of the modules may be selected according to actual needs to achieve the purpose of this embodiments. It can be understood and implemented without creative labor by a person of ordinary skill in the art.

Above, the method and apparatus for the present disclosure are illustrated based on embodiments and use cases. In addition, the present disclosure also provides an electronic device and a computer-readable storage medium, which are illustrated below.

Reference is now made to FIG. 5 which shows a schematic structural diagram of an electronic device (for example a terminal device or a server) 800 suitable for implementing embodiments of the present disclosure. The terminal device in embodiments of the present disclosure may include, but is not limited to, a mobile terminal such as a mobile phone, a laptop computer, a digital broadcast receiver, a personal digital assistant (PDA), a portable android device (PAD), a portable media player (PMP), a vehicle-mounted terminal (for example, a vehicle-mounted navigation terminal), and/or the like, and a fixed terminal such as a digital TV, a desktop computer, and the like. The electronic device as shown is only an example and should not suggest any limitation to the functions and use scope of embodiments of the present disclosure.

The electronic device 800 may include a processing device (e.g., a central processing unit, a graphics processor, etc.) 801 that may perform various suitable actions and processes in accordance with a program stored in a read only memory (ROM) 802 or a program loaded into a random access memory (RAM) 803 from a storage device 808. A plurality of programs and data necessary for the operation of the electronic device 800 are also stored in the RAM 803. The processing device 801, the ROM 802 and the RAM 803 are connected to each other via a bus 804. An input/output (I/O) interface 805 is also connected to the bus 804.

In general, the following devices may be connected to the I/O interface 805: an input device 806 including, for example, a touch screen, a touch pad, a keyboard, a mouse, a camera, a microphone, an accelerometer, a gyroscope, and/or the like; an output device 807 including, for example, a liquid crystal display (LCD), a speaker, a vibrator, and the like; the storage device 808 including, for example, a magnetic tape, a hard disk, and the like; and a communication device 809. The communication device 809 may allow the electronic device 800 to communicate in wirelessly or wired ways with other devices to exchange data. Although the electronic device 800 is shown to have various devices, it should be understood that it is not required to implement or have all of the illustrated devices. More or fewer devices may alternatively be implemented or provided.

In particular, according to embodiments of the present disclosure, the processes described above with reference to the flowcharts may be implemented as computer software programs. For example, embodiments of the present disclosure include a computer program product including a computer program carried on a computer readable medium. The computer program includes a program code for performing the method as shown in the flowchart. In such embodiments, the computer program may be downloaded and installed from the network through the communication device 809, or installed from the storage device 808, or installed from the ROM 802. When the computer program is executed by the processing device 801, the above-described functions defined in the method are performed, according to embodiments of the present disclosure.

It should be noted that the computer readable medium described above in the present disclosure may be a computer readable signal medium or a computer readable storage medium, or any combination of the above. The computer-readable storage medium may be, for example, but is not limited to, an electronic, magnetic, optical, electromagnetic, infrared or semiconductor system, apparatus, or device, or any suitable combination of the above. More specific examples of the computer readable storage medium may include, but are not limited to, an electrical connection having one or more cables, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, a computer readable storage medium may be any tangible medium that may contain or store a program that may be used by or in combination with an instruction execution system, apparatus, or device. In the present disclosure, a computer readable signal medium may include a data signal propagated in a baseband or as part of a carrier wave carrying computer readable program code. Such propagated signals may take a variety of forms, including, but not limited to, electromagnetic signals, optical signals, or any suitable combination of the above. The computer readable signal medium may also be any computer readable medium, other than a computer readable storage medium, which transmits, propagates or communicates a program for use by or in connection with an instruction-executing system, apparatus or device. The program code included in the computer readable medium may be transmitted by any suitable medium, including, but not limited to: a cable, an optical fiber. RF (radio frequency), etc., or any other means.

The above computer readable medium may be included in the above electronic device, or may exist separately and not be installed in the electronic device.

The above computer readable medium carries one or more programs, and when the one or more programs are executed by the electronic device, the one or more programs cause the electronic device to execute the method shown in the above embodiments.

Computer program code for performing the operations of the present disclosure may be written in one or more programming languages or combinations thereof, including an object-oriented programming language such as Java. Smalltalk. C++ and/or the like and conventional procedural programming languages, such as the “C” language or similar programming languages. The program code may be executed entirely on the user's computer, partly on the user's computer, as a stand-alone software package, partly on the user's computer and partly on a remote computer or entirely on the remote computer or server. In the case involving a remote computer, the remote computer may be connected to the user's computer through any type of network, including a local area network (LAN) or a wide area network (WAN), or connected to an external computer (for example, over the Internet via an Internet service provider).

The flowcharts and block diagrams in the accompanying drawings illustrate the architecture, functionality and operation of systems, methods and computer program products that may be implemented according to various embodiments of the present disclosure. In this regard, each block in the flowchart or block diagrams may represent a module, a program segment or a portion of code, which includes one or more executable instructions for implementing the specified logical function(s). It should also be noted that, in some alternative implementations, the functions noted in the blocks may occur in a different order than that noted in the accompanying drawings. For example, two consecutively represented blocks may actually be executed substantially in parallel, and they may sometimes be executed in a reverse order, depending upon the functionality involved. It should also be noted that each block in the block diagrams and/or flowchart, and combinations of the blocks in the block diagrams and/or flowcharts, may be implemented with a dedicated hardware-based system that performs the specified function or operation, or may be implemented with a combination of dedicated hardware and computer instructions.

The units described in the embodiments of the present disclosure may be implemented by software or hardware. Herein, the name of the unit does not constitute a limitation to the unit itself in some cases. For example, the first obtaining unit may also be described as “a unit to obtain at least two internet protocol addresses”.

The functions described herein above may be performed, at least in part, by one or more hardware logic components. For example, without limitation, example types of hardware logic components that may be used include: Field-programmable Gate Arrays (FPGAs), Program-specific Integrated Circuits (ASICs). Program-specific Standard Products (ASSPs), System-on-a-chip systems (SOCs), Complex Programmable Logic Devices (CPLDs), and/or the like.

In the context of this disclosure, a machine-readable medium may be a tangible medium that may contain or store a program for use by or in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus, or device, or any suitable combination of the above. More specific examples of machine-readable storage medium would include an electrical connection based on one or more cables, a portable computer disk, a hard disk, a random access memory (RAM), a read-only memory (ROM), an erasable programmable read-only memory (EPROM or flash memory), an optical fiber, a convenient compact disc read-only memory (CD-ROM), an optical storage device, a magnetic storage device, or any suitable combination of the above.

According to one or more embodiments of the present disclosure, a method of information processing is provided, including:
in response to processing of a first item, determining processing information of the first item, the processing information including: processing path information and/or processing duration information for processing the first item;
determining whether the processing information satisfies a predetermined judgment condition; and
in response to the processing information satisfying the judgment condition, display the first predetermined information.

According to one or more embodiments of the present disclosure, a method of information processing is provided which satisfies at least one of:
the processing path information includes: information on whether to enter a details page of the first item during a processing procedure; and/or
the processing duration information includes: a stay duration on the details page.

According to one or more embodiments of the present disclosure, a method of information processing is provided, where determining whether the processing information satisfies the predetermined judgment condition includes:
in response to the details page being not entered during the processing procedure, determining that the judgment condition is satisfied; and
in response to the details page being entered during the processing procedure, determining that whether the judgment condition is satisfied based on the stay duration on the details page.

According to one or more embodiments of the present disclosure, a method of information processing is provided, where determining whether the processing information satisfies the predetermined judgment condition includes:
in response to the details page being not entered during the processing procedure and the first item being not processed in a predetermined mode, determining that the judgment condition is satisfied;
in response to the details page being entered during the processing procedure, determining that whether the judgment condition is satisfied based on the stay duration on the details page; and
in response to the first item being processed in the predetermined mode, determining that the judgment condition is unsatisfied.

According to one or more embodiments of the present disclosure, a method of information processing is provided, where the predetermined mode includes at least one of: batch processing of items, or processing of items via an open interface.

According to one or more embodiments of the present disclosure, a method of information processing is provided, where determining whether the judgment condition is satisfied based on the stay duration on the details page includes:
in response to the stay duration being less than a predetermined duration, determining that the judgment condition is satisfied; and
in response to the stay duration being greater than or equal to the predetermined duration, determining that the judgment condition is unsatisfied.

According to one or more embodiments of the present disclosure, a method of information processing is provided which satisfies at least one of:
the details page is not entered for processing by: processing the first item via a processing control in a notification message corresponding to the first item, or processing the first item via a processing control in an item list;
the details page is entered for processing by: displaying the details page for processing, after the notification message is triggered; or displaying the details page for processing, after the item list is triggered.

According to one or more embodiments of the present disclosure, a method of information processing is provided, where in response to a same user entering the details page of the first item using different terminals, the stay duration on the details page is calculated from an earliest time point when the user enters the details page using the different terminals.

According to one or more embodiments of the present disclosure, a method of information processing is provided, where in response to the details page being entered during the processing procedure and processing of the first item being completed outside the details page, whether the judgment condition is satisfied is determined according to a duration from entering the details page to completing the processing of the first item.

According to one or more embodiments of the present disclosure, a method of information processing is provided, where in response to the processing of the first item, before determining the processing information on the first item, the method further includes:
determining whether a first function is enabled for the first item;
in response to the first function being enabled, determining the processing information of the first item; and
in response to the first function being disabled, skipping the determining of the processing information of the first item.

According to one or more embodiments of the present disclosure, a method of information processing is provided, where the first function is enabled by default for a predetermined type of items, the predetermined type of items including at least one of: an amount-related item, or an item with an importance level reaching the predetermined level.

According to one or more embodiments of the present disclosure, a method of information processing is provided, further including:
determining whether a second function is enabled for the first item; and
in response to the second function being disabled, determining that the first item is only allowed to be processed after entering a details page of the first item.

According to one or more embodiments of the present disclosure, a method of information processing is provided, where the first item is an item of a target node of a processing flow of a target task; and
displaying the first predetermined information includes: displaying the first predetermined information in an area associated with the target node of the processing flow.

According to one or more embodiments of the present disclosure, a method of information processing is provided, where the first predetermined information is not displayed in a printing result during printing the first item.

According to one or more embodiments of the present disclosure, a method of information processing is provided, further including:
obtaining statistical data of the first predetermined information generated during the processing procedure of the item, and
displaying the statistical data.

According to one or more embodiments of the present disclosure, an apparatus for information processing is provided, including:
a determining unit configured to in response to processing of a first item, determine processing information of the first item, the processing information including: processing path information and/or processing duration information for processing the first item;
a judgment unit configured to determine whether the processing information satisfies a predetermined judgment condition; and
a displaying unit configured to in response to the processing information satisfying the judgment condition, display first predetermined information.

According to one or more embodiments of the present disclosure, an electronic device is provided, including:
at least one memory and at least one processor;
where the at least one memory is configured to store program codes, and the at least one processor is configured to call the program codes stored in the at least one memory to perform any one of the above methods.

The above description is only example embodiments of the present disclosure and an illustration of the technical principles. It should be understood by those skilled in the art that the scope of the disclosure involved in the present disclosure is not limited to the technical solution formed by the specific combination of the above technical features, but also covers other technical solutions formed by any combination of the above technical features or their equivalent features without departing from the above disclosed concept. For example, a technical solution formed by replacing the above-mentioned features with technical features having similar functions as disclosed in the present disclosure (but not limited to those technical features).

In addition, although the operations are depicted in a particular order, this should not be understood as requiring that the operations are performed in the particular order shown or in a sequential order. Multitasking and parallel processing may be advantageous in certain circumstances. Likewise, although several specific implementation details are included in the above discussion, these should not be construed as limiting the scope of the present disclosure. Certain features that are described in the context of separate embodiments may also be implemented in combination in a single embodiment. Conversely, various features that are described in the context of a single embodiment may also be implemented in multiple embodiments, either individually or in any suitable sub-combination.

Although the present subject matter has been described in language specific to structural features and/or methodological actions, it should be understood that the subject matter defined in the appended claims is not necessarily limited to the specific features or actions described above. Rather, the specific features and actions described above are only example forms of implementing the claims.

1. A method of information processing, comprising:
in response to processing of a first item, determining processing information of the first item, the processing information including: processing path information and/or processing duration information for processing the first item;
determining whether the processing information satisfies a predetermined judgment condition; and
in response to the processing information satisfying the judgment condition, display first predetermined information.

2. The method of claim 1, wherein:
the processing path information includes: information on whether to enter a details page of the first item during a processing procedure; and/or
the processing duration information includes: a stay duration on the details page.

3. The method of claim 2, wherein determining whether the processing information satisfies the predetermined judgment condition comprises:
in response to the details page being not entered during the processing procedure, determining that the judgment condition is satisfied; and
in response to the details page being entered during the processing procedure, determining whether the judgment condition is satisfied based on the stay duration on the details page.

4. The method of claim 2, wherein determining whether the processing information satisfies the predetermined judgment condition comprises:
in response to the details page being not entered during the processing procedure and the first item being not processed in a predetermined mode, determining that the judgment condition is satisfied;
in response to the details page being entered during the processing procedure, determining whether the judgment condition is satisfied based on the stay duration on the details page; and
in response to the first item being processed in the predetermined mode, determining that the judgment condition is unsatisfied.

5. The method of claim 4, wherein
the predetermined mode includes at least one of: batch processing of items, or processing of items via an open interface.

6. The method of claim 3, wherein determining whether the judgment condition is satisfied based on the stay duration on the details page comprises:
in response to the stay duration being less than a predetermined duration, determining that the judgment condition is satisfied; and
in response to the stay duration being greater than or equal to the predetermined duration, determining that the judgment condition is unsatisfied.

7. The method of claim 2, wherein:
the details page is not entered for processing by: processing the first item via a processing control in a notification message corresponding to the first item, or processing the first item via a processing control in an item list; and
the details page is entered for processing by: displaying the details page for processing, after the notification message is triggered; or displaying the details page for processing, after the item list is triggered.

8. The method of claim 2, wherein
in response to a same user entering the details page of the first item using different terminals, the stay duration on the details page is calculated from an earliest time point when the user enters the details page using the different terminals.

9. The method of claim 2, wherein
in response to the details page being entered during the processing procedure and processing of the first item being completed outside the details page, whether the judgment condition is satisfied is determined according to a duration from entering the details page to completing the processing of the first item.

10. The method of claim 1, wherein the method further comprises: in response to the processing on the first item, before determining the processing information on the first item,
determining whether a first function is enabled for the first item;
in response to the first function being enabled, determining the processing information of the first item; and
in response to the first function being disabled, skipping the determining of the processing information of the first item.

11. The method of claim 10, wherein
the first function is enabled by default for a predetermined type of items, the predetermined type of items including at least one of: an amount-related item, or an item with an importance level reaching a predetermined level.

12. The method of claim 1, further comprising:
determining whether a second function is enabled for the first item; and
in response to the second function being disabled, determining that the first item is only allowed to be processed after entering a details page of the first item.

13. The method of claim 1, wherein
the first item is an item of a target node of a processing flow of a target task; and
displaying the first predetermined information comprises: displaying the first predetermined information in an area associated with the target node of the processing flow.

14. The method of claim 1, wherein the first predetermined information is not displayed in a printing result during printing of the first item.

15. The method of claim 1, further comprising:
obtaining statistical data of the first predetermined information generated during the processing procedure of the item; and
displaying the statistical data.

16. (canceled)

17. An electronic device comprising:
at least one memory and at least one processor;
wherein the at least one memory is configured to store program codes, and the at least one processor is configured to call the program codes stored in the at least one memory to perform acts comprising:
in response to processing of a first item, determining processing information of the first item, the processing information including: processing path information and/or processing duration information for processing the first item;
determining whether the processing information satisfies a predetermined judgment condition; and
in response to the processing information satisfying the judgment condition, display first predetermined information.

18. A non-transitory computer readable storage medium for storing program codes, the program codes, upon run by a processor, causing the processor to perform acts comprising:
in response to processing of a first item, determining processing information of the first item, the processing information including: processing path information and/or processing duration information for processing the first item;
determining whether the processing information satisfies a predetermined judgment condition; and
in response to the processing information satisfying the judgment condition, display first predetermined information.

19. The electronic device of claim 17, wherein:
the processing path information includes: information on whether to enter a details page of the first item during a processing procedure; and/or
the processing duration information includes: a stay duration on the details page.

20. The electronic device of claim 19, wherein determining whether the processing information satisfies the predetermined judgment condition comprises:
in response to the details page being not entered during the processing procedure, determining that the judgment condition is satisfied; and
in response to the details page being entered during the processing procedure, determining whether the judgment condition is satisfied based on the stay duration on the details page.

21. The electronic device of claim 19, wherein determining whether the processing information satisfies the predetermined judgment condition comprises:
in response to the details page being not entered during the processing procedure and the first item being not processed in a predetermined mode, determining that the judgment condition is satisfied;
in response to the details page being entered during the processing procedure, determining whether the judgment condition is satisfied based on the stay duration on the details page; and
in response to the first item being processed in the predetermined mode, determining that the judgment condition is unsatisfied.
